(19) United States
(12) Patent Application Publication
(10) Pub. No.: US 2026/0311566 A1
(43) Pub. Date: Oct. 8, 2026

(54) Blockchain-Based Token System for Competitive Sports Wagering and Performance-Based Rewards

(71) Applicant: Vernon Keith Mills, Girard, OH (US)

(72) Inventor: Vernon Keith Mills, Girard, OH (US)

(21) Appl. No.: 19/637,186

(22) Filed: Apr. 2, 2026

Related U.S. Application Data
(60) Provisional application No. 63/783,449, filed on Apr. 4, 2025.

(51) Int. Cl. G07F 17/32; G06Q 20/36

(52) U.S. Cl. CPC G07F 17/3288; G06Q 20/36

(57) ABSTRACT

A blockchain-based system is disclosed for facilitating wagering, rewards, and financial interactions within competitive sports environments, specifically pickleball. The system includes a native digital token and a plurality of smart contracts configured to automate match-based wagering, reward distribution, and transaction settlement based on verified match outcomes. A decentralized ledger records token transfers, player performance metrics, and achievement data. The system further includes an incentive framework providing performance-based recognitions and token rewards, and a tokenomics model governing issuance, allocation, and governance. The platform integrates with real-world sporting events and supports peer-to-peer transactions, tournament participation, and digital asset exchanges. By combining athletic performance with decentralized financial mechanisms, the system enables transparent, automated, and trustless monetization of competitive play within a secure blockchain infrastructure.

### FEDERALLY SPONSORED RESEARCH

Not Applicable

### SEQUENCE LISTING OR PROGRAM

Not Applicable

### FIELD OF THE INVENTION

The present invention relates generally to digital currency systems and, more particularly, to a blockchain-based cryptocurrency integrated with smart contract functionalities designed to facilitate wagering, compensation, and investment within the context of organized competitive sports, specifically the sport of pickleball.

### BACKGROUND OF THE INVENTION

With the rapid growth in both the popularity of pickleball and the adoption of cryptocurrency technologies, there exists an untapped opportunity to combine these domains to enable new economic models for personal and community-level investment. Pickleball, which has seen explosive growth across diverse demographic groups, especially among ages 25-34 and 65+, offers a unique platform for social, recreational, and competitive engagement.

Traditional cryptocurrencies have primarily been used for investment, trading, and payments. However, no current solution provides a seamless integration between decentralized financial technologies and real-world recreational or competitive sports in a way that facilitates self-investment and performance-based earnings.

### SUMMARY OF THE INVENTION

The invention disclosed herein provides a novel blockchain-based system, including a native cryptocurrency token (referred to herein as “The present invention”), and a suite of smart contract mechanisms specifically tailored for pickleball players and tournaments. The system enables players to wager matches, earn rewards, and utilize tokens for tournament entry fees, prizes, and in-platform achievements, thereby transforming play into a personalized financial ecosystem.

The system includes the following novel features. Smart contract-enabled match wagering that automates the transaction and settlement of wagers based on match outcomes.

A blockchain-secured ledger maintaining all token transfers, match outcomes, and player achievements.

A dynamic tokenomics model that promotes both scarcity and accessibility, with allocations for rewards, community incentives, development, and governance.

A recognition and incentive framework that includes awards such as Achievement Award, Top Earner Award, Statesman Award, and Respect Your Elder Award to reward user participation and engagement.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a System Architecture Diagram showing the components of the platform: blockchain network, smart contract module, user wallets, match oracle inputs, reward module, and interface layer.

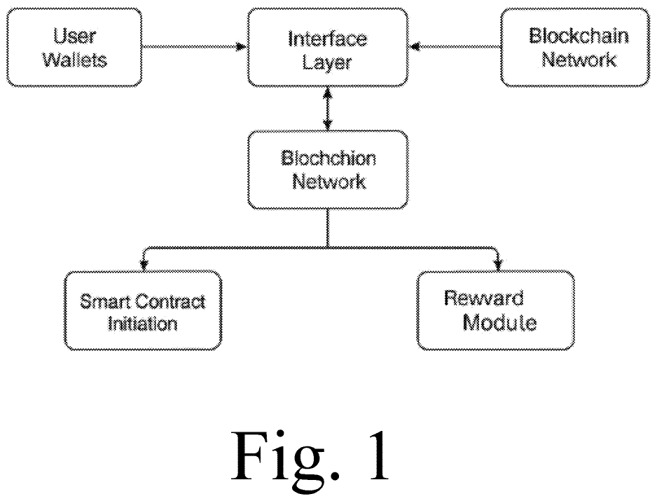

FIG. 2 is a Smart Contract Wager Flowchart demonstrating the steps of a match wager: user staking→smart contract initiation→match result input→automatic token distribution→ledger update.

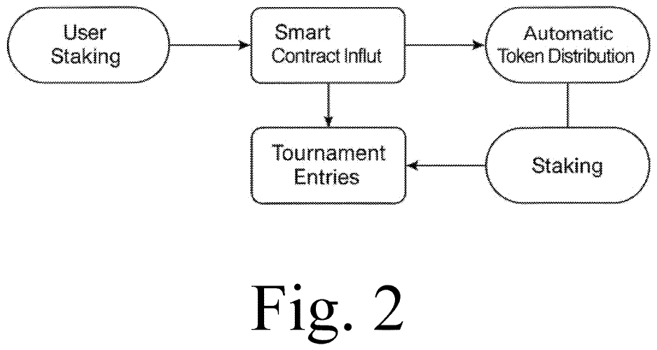

FIG. 3 is a Token Utility Model Diagram outlining the use cases for tokens, including wagering, purchasing goods, tournament entries, and staking.

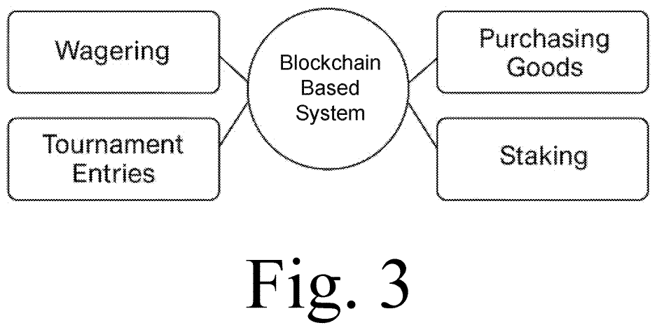

FIG. 4 is an Incentive Structure Infographic-style tree showing different user types and the achievement paths to earn various awards.

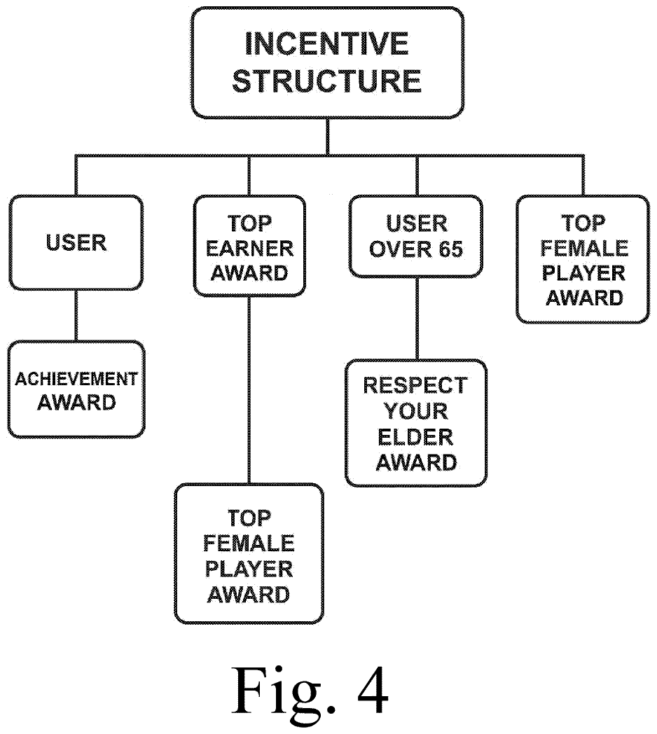

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and an example of the present disclosure and are made merely for the purposes of providing a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The invention utilizes a blockchain infrastructure built on a hybrid consensus mechanism that integrates both Proof of Stake (PoS) and Byzantine Fault Tolerance (BFT). This combination ensures a secure, scalable, and energy-efficient network architecture. Its decentralized structure distributes control across multiple nodes, thereby eliminating centralized points of failure and providing strong resistance against fraud, tampering, or system manipulation.

At the core of this ecosystem is the native digital token, named “The present invention,” which operates as a versatile cryptocurrency within the platform. The present invention can be used to place wagers on pickleball match outcomes in both singles and doubles formats. The token also functions as a form of reward, distributed to players as prizes in both formal and informal matches and tournaments. Beyond its competitive utility, users may accumulate and redeem The present invention tokens for access to future events, merchandise, or affiliated services. Furthermore, the token may be traded or exchanged within the broader decentralized finance ecosystem, including participation on supported third-party exchanges.

To enable fair, secure, and automated match-based wagering, the platform employs smart contracts. Prior to the start of any match, players commit a predetermined number of The present invention tokens to a smart contract specifically created for that match. Upon completion, the outcome is verified through a trusted data source or oracle. Once the result is confirmed, the smart contract executes autonomously, distributing the tokens according to the match outcome, without requiring human intervention.

Incentivizing participation and sustained engagement is a key aspect of the invention. The platform implements a dynamic achievement and rewards structure designed to promote long-term use and community involvement. For instance, users who earn over 1,000 tokens within a year are recognized with an Achievement Award. The individual with the highest annual earnings receives the Top Earner Award, while state-specific leaders receive the Statesman Award. To further promote inclusivity, special recognition is given to top-performing players over the age of 65 through the Respect Your Elder Award, and outstanding female players are acknowledged with the Top Female Player Award. These honors are based on transparent, on-chain performance metrics and may come with additional token incentives or exclusive privileges within the ecosystem.

The system is further designed to integrate with real-world social and competitive contexts. It is compatible with local and national pickleball events and can connect with community platforms to encourage widespread adoption. The system's accessibility makes it suitable for users of all ages and skill levels, including adaptive athletes and individuals from underrepresented communities.

The present invention operates within a defined tokenomic framework that controls issuance and maintains long-term value. Token supply is capped and subject to a structured emission schedule. Additionally, the platform includes built-in governance tools that empower the community to vote on key updates, such as protocol changes, reward structures, or token allocation strategies, ensuring democratic control and continued relevance.

The utility of the platform spans multiple functional domains. The present invention may be used for retail transactions within the pickleball economy, facilitating the purchase of goods and services. It supports peer-to-peer remittances without the need for intermediaries, and serves as a foundation for decentralized financial (DeFi) applications, such as token staking, lending, or borrowing. Moreover, it enables the digital tokenization of real-world assets, allowing items such as tournament prizes or equipment to be represented and transferred on the blockchain.

Overall, this invention introduces significant advantages over prior systems. It fuses physical athletic engagement with decentralized financial technology, providing a means for users to monetize recreational and competitive performance through tradable digital assets. The platform encourages broader adoption of cryptocurrency by making it relevant and rewarding across generational and community lines. By leveraging automated smart contracts and a secure blockchain backbone, it enables a transparent, tamper-resistant, and trustless financial ecosystem embedded within a popular sport.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference.

It will be understood that, although a number of patent applications, patents, and other references are referred to herein, such reference does not constitute an admission that any of these documents form part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

The system is set to run on a computing device or mobile electronic device. A computing device or mobile electronic device on which the present invention can run would be comprised of a CPU, storage device, keyboard, monitor or screen, CPU main memory and a portion of main memory where the system resides and executes. Any general-purpose computer, smartphone, or other mobile electronic device with an appropriate amount of storage space is suitable for this purpose.

Computer and mobile electronic devices like these are well known in the art and are not pertinent to the invention. The system can also be written in several different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As for a further discussion of the manner of usage and operation of the present invention, the same should be apparent from the above description. Accordingly, no further discussion relating to the manner of usage and operation will be provided.

What is claimed is:

1. A system for facilitating blockchain-based wagering in a competitive sports environment, comprising:
a decentralized blockchain network comprising a distributed ledger and a plurality of validating nodes configured to record and validate transactions;
a native token stored on the decentralized blockchain network and configured for staking in connection with a sporting event;
a smart contract execution engine implemented on the decentralized blockchain network and configured to (i) establish a wager-specific smart contract prior to commencement of the sporting event, (ii) lock a quantity of the native token from at least two participants in an escrow state, and (iii) automatically execute a settlement operation upon satisfaction of one or more predefined conditions;
an oracle subsystem configured to receive match outcome data from at least one of an external data source or authorized input, to validate the match outcome data, and to transmit verified match outcome data to the smart contract execution engine;
wherein the smart contract execution engine is further configured to automatically release the escrowed native token to a winning participant based on the verified match outcome data received from the oracle subsystem; and
a user interface associated with a digital wallet and configured to enable participants to initiate the wager, stake the native token, and receive settlement results.

2. The system of claim 1, wherein
the decentralized blockchain network utilizes a hybrid consensus algorithm combining Proof of Stake and Byzantine Fault Tolerance to validate transactions and secure the distributed ledger against manipulation and double-spending.

3. The system of claim 1, wherein
the native token is configured to serve as a medium of exchange for tournament entry fees, prize disbursements, and platform-based transactions, and is further tradable on decentralized or centralized exchanges.

4. The system of claim 1, wherein
the smart contract execution engine is further configured to execute the settlement operation only upon receipt of the verified match outcome data from the oracle subsystem and to prevent release of escrowed tokens prior to such receipt.

5. The system of claim 1, wherein
the user interface comprises a digital wallet accessible via web-based and mobile applications and is configured to enable users to manage the native token, view match-related data, and access performance-related information.

6. The system of claim 1, further comprising
an incentive module configured to track token-based earnings based on transactions recorded on the decentralized blockchain network and to distribute recognition awards based on verifiable user activity.

7. The system of claim 1, wherein
the decentralized blockchain network includes governance functionality enabling token holders to propose, vote on, and ratify system updates including modifications to smart contract parameters, token allocation, and incentive structures.

8. The system of claim 1, wherein
initiation of the wager is secured by at least one of multi-signature authorization or multi-factor authentication associated with a user wallet prior to activation of the smart contract execution engine.

9. The system of claim 1, wherein
match outcome data and associated transaction data are recorded on the decentralized blockchain network in an immutable format enabling auditability, historical analysis, and transparency.

10. The system of claim 1, further comprising
a rewards wallet associated with a user profile and implemented on or in communication with the decentralized blockchain network, the rewards wallet being configured to receive the native token automatically distributed by the smart contract execution engine upon execution of the settlement operation, and to record receipt of the native token as a transaction on the distributed ledger.

11. A method for executing blockchain-based wagering in a competitive sports environment, comprising:
registering a plurality of user wallets on a decentralized blockchain network;
deploying, by a smart contract execution engine, a wager-specific smart contract associated with a sporting event;
locking, by the wager-specific smart contract, a quantity of a native token from at least two participants in an escrow state on the decentralized blockchain network prior to commencement of the sporting event;
receiving, by an oracle subsystem, match outcome data from at least one of an external data source or authorized input;
validating, by the oracle subsystem, the match outcome data;
transmitting, by the oracle subsystem, verified match outcome data to the smart contract execution engine;
executing, by the smart contract execution engine, a settlement operation in response to the verified match outcome data; and
automatically transferring, by the smart contract execution engine, the escrowed native token to a winning participant and recording the transfer on a distributed ledger of the decentralized blockchain network.

12. The method of claim 11, wherein
initiating the wager comprises receiving user input specifying a token amount and confirming agreement of participating users prior to locking the native token in the escrow state.

13. The method of claim 11, wherein
the decentralized blockchain network is updated to record staking, execution of the settlement operation, and allocation of the native token as transactions on the distributed ledger.

14. The method of claim 11, further comprising
determining, based on transactions recorded on the decentralized blockchain network, user performance metrics and awarding recognition indicators based on cumulative token earnings, rankings, or participation metrics.

15. The method of claim 11, wherein
the oracle subsystem comprises a plurality of validation sources configured to aggregate match outcome data and perform a verification process prior to transmitting the verified match outcome data to the smart contract execution engine.

16. The method of claim 11, further comprising
redeeming, via a user interface associated with a user wallet, the native token for at least one of tournament entry, goods, or services through a platform-connected transaction.

17. The method of claim 11, further comprising
receiving, via the decentralized blockchain network, governance inputs from users and executing protocol modifications based on token-weighted voting recorded on the distributed ledger.

18. The method of claim 11, wherein
the native token is utilized as a unit of account within the decentralized blockchain network to facilitate peer-to-peer transfers and participation in decentralized finance operations including staking, lending, or borrowing.

19. The method of claim 11, further comprising
performing cryptographic key management and transaction signing operations using private keys associated with the user wallets to authorize execution of transactions on the decentralized blockchain network.

20. A non-transitory computer-readable medium storing instructions that, when executed by one or more processors, cause a system to perform a method comprising:
deploying a wager-specific smart contract on a decentralized blockchain network;
locking a quantity of a native token from at least two participants in an escrow state associated with a sporting event;
receiving and validating match outcome data using an oracle subsystem;
transmitting verified match outcome data to a smart contract execution engine;
executing a settlement operation based on the verified match outcome data; and
automatically transferring the escrowed native token to a winning participant and recording the transfer on a distributed ledger of the decentralized blockchain network.
